(19) United States
(12) Patent Application Publication
(10) Pub. No.: US 2021/0080397 A1
(43) Pub. Date: Mar. 18, 2021

(54) GAS DETECTION SHEET AND ELECTROCHEMICAL ELEMENT COMPRISING GAS DETECTION SHEET

(71) Applicant: TDK CORPORATION, Tokyo (JP)

(72) Inventors: Tomohiko KATO, Tokyo (JP); Takayuki MARUYAMA, Tokyo (JP)

(73) Assignee: TDK CORPORATION, Tokyo (JP)

(21) Appl. No.: 16/963,735

(22) PCT Filed: Jan. 22, 2019
(86) PCT No.: PCT/JP2019/001759

§ 371 Date: Jul. 21, 2020

(30) Foreign Application Priority Data
Jan. 23, 2018 (JP) 2018-009051

(51) Int. Cl. G01N 21/78; H01M 10/48; H01G 11/80; H01G 9/10; G01N 31/22

(52) U.S. Cl. CPC G01N 21/78; H01M 10/48; G01N 31/223; H01G 9/10; H01G 11/80

(57) ABSTRACT

A gas detection sheet has good gas detection sensitivity and excellent adhesion between a support and a porous coordination polymer, and an electrochemical element includes the gas detection sheet. The gas detection sheet includes a gas detection sheet support and a porous coordination polymer represented by general formula (1) supported on the support.

Feₓ(Pyrazine)[Ni_{1-y}M_{y}(CN)₄] (1)

(0.95≤x≤1.05, M=Pd, Pt, 0≤y<0.15)

By using the gas detection sheet wherein the gas detection sheet further contains a binder of 4% to 60% by mass based on the mass of the gas detection sheet, the gas detection sensitivity is excellent and the adhesion between the support and the porous coordination polymer is excellent.

### BACKGROUND OF THE INVENTION

### Field of the Invention

The invention relates to a gas detection sheet and an electrochemical element comprising the gas detection sheet.

Priority is claimed on Japanese Patent Application No. 2018-009051, filed Jan. 23, 2018, the content of which is incorporated herein by reference.

### Description of Related Art

With the recent miniaturization and enhancement of functions of portable electronic devices, further miniaturization, weight reduction and capacity enhancement of electrochemical elements are expected. Electrochemical elements can be fabricated in a variety of forms, but the forms typically include square, cylindrical, and pouch types. In particular, since the pouch-type electrochemical element uses a pouch-type case formed of a sheet such as an aluminum laminate film, it has advantages in that it can be manufactured in a light and various forms, and the manufacturing process is simple. However, there is a problem that scratches or swelling due to an increase in internal pressure are more likely to occur than in the case of the cylindrical type or the square type.

Among electrochemical elements, a mixed solvent of a cyclic carbonate such as ethylene carbonate and a chain carbonate such as diethyl carbonate is generally used as a solvent of an electrolyte for lithium ion secondary batteries and lithium ion capacitors. Propylene carbonate is used as a solvent of an electrolyte for electric double layer capacitors, and ethylene glycol is used as a solvent of an electrolyte for aluminum electrolytic capacitors. When the sealing property of the case of the electrochemical element is insufficient, or when a pinhole or the like is generated in the case, a part of these solvents volatilizes as vapor and leaks out of the sealed container. And it causes problems such as an abnormal odor and a deterioration in characteristics.

Various methods of inspecting leaked gas from a sealed container have been proposed, and a method of detecting leaked gas using a porous coordination polymer has been proposed in Patent Document 1. However, if the amount of the porous coordination polymer supported on the support is increased in order to improve visibility, there is a problem in that the porous coordination polymer material particles easily fall off from the support depending on handling method.

[Patent Document 1] WO2016/047232 A1

### SUMMARY OF THE INVENTION

The present invention has been made in view of the above problems, and it is an object of the present invention to provide a gas detection sheet having excellent gas detection sensitivity and excellent adhesion between a support and a porous coordination polymer by using an appropriate binder type and amount.

The present inventors have diligently studied and found that the above object can be achieved by using a gas detection sheet characterized in that a porous coordination polymer represented by general formula (1) is supported on a support and a binder is contained in an amount of 4% to 60% by mass based on a mass of the gas detection sheet.

Feₓ(Pyrazine)[Ni_{1-y}M_{y}(CN)₄] (1)

(0.95≤x≤1.05, M=Pd, Pt, 0≤y<0.15)

That is, according to the present invention, the following are provided.

[1] A gas detection sheet comprising:

a support, and

a porous coordination polymer which is represented by general formula (1) and supported on the support,

Feₓ(Pyrazine)[Ni_{1-y}M_{y}(CN)₄] (1)

wherein 0.9≤x≤1.05, M=Pd, Pt, 0≤y<0.15), and

further comprising a binder of 4% to 60% by mass based on a mass of the gas detection sheet.

[2] The gas detecting sheet according to [1],

wherein the support is a fiber sheet comprising fibers, and

a ratio (B/A) of an outer circumferential length B of the cross section to a circumferential length A of an inscribed circle of a cross section of a single fiber of the fibers is 1.1 or more.

[3] An electrochemical element comprising the gas detection sheet according to [1] or [2],

wherein the gas detection sheet is provided near a surface, and

the electrochemical element uses an electrolyte comprising a volatile organic compound.

According to the present invention, it is possible to provide a gas detection sheet having excellent gas detection sensitivity and excellent adhesion between a support and a porous coordination polymer, and an electrochemical element comprising the gas detection sheet.

### BRIEF DESCRIPTION OF THE DRAWINGS

FIG. 1 is a schematic diagram showing a basic chemical structure of a porous coordination polymer according to an embodiment of the present invention.

FIG. 2 is a schematic diagram showing a lithium ion secondary battery according to an embodiment of the present invention.

FIG. 3 is a schematic cross-sectional view of an example of a fiber according to an embodiment of the present invention.

FIG. 4 is a schematic cross-sectional view of another example of a fiber according to an embodiment of the present invention.

### DETAILED DESCRIPTION OF THE INVENTION

An embodiment for carrying out the present invention will be described in detail with reference to the drawings. The present invention is not limited by the contents described in the following embodiments.

The gas detection sheet of the present embodiment has a support, a porous coordination polymer which is represented by the following general formula (1) and supported on the support, and further contains a binder of 4% to 60% by mass based on the mass of the gas detection sheet.

Feₓ(Pyrazine)[Ni_{1-y}M_{y}(CN)₄] (1)

(0.95≤x≤1.05, M=Pd, Pt, 0≤y<0.15)

(Porous Coordination Polymer)

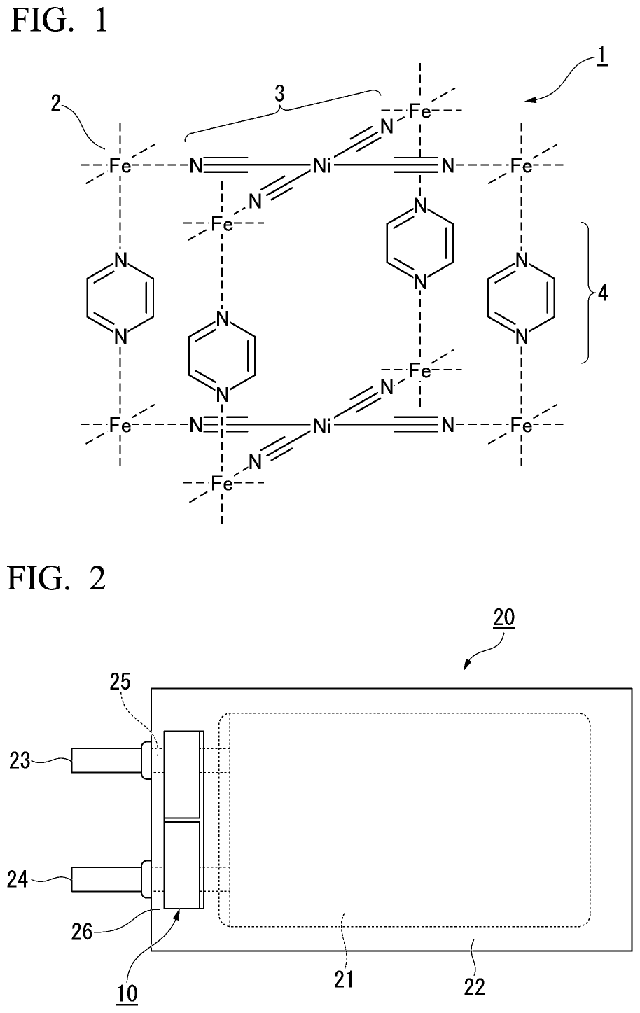

As shown in FIG. 1, the porous coordination polymer 1 represented by the general formula (1) used for the gas detection sheet of the present embodiment has a structure in which tetracyanonickelate ion 3 and pyrazine 4 are coordinated to iron ion 2 and then a jungle gym type is grown self-assembly and regularly, and various molecules can be adsorbed in an inner space. A part of nickel may be substituted with at least one of palladium and platinum.

In the porous coordination polymer 1, there is a phenomenon called spin crossover in which the electronic configuration of iron ions changes between two states called a high-spin state and a low-spin state by external stimulation such as heat, pressure, and adsorption of molecules. The spin change is generally said to be in the order of tens of nanoseconds, and is characterized by a very fast response rate.

The high-spin state refers to a state in which electrons are arranged in five orbitals of d electrons of iron ions in the complex in such a way that the spin angular momentum is maximized according to the Hund's law, and the low-spin state refers to a state in which electrons are arranged in such a way that the spin angular momentum is minimized. In other words, if the spin-crossover phenomenon due to the adsorption of molecules onto the porous coordination polymer is utilized, it becomes possible to use it as a detection material for quickly detecting a specific molecule.

The porous coordination polymer in the high-spin state is orange, and changes to a red-purple color in the low-spin state when sufficiently cooled by liquid nitrogen or the like. When exposed to a gas of a specific organic compound such as acetonitrile or acrylonitrile, the gas is adsorbed inside the crystal, and a low spin state is obtained. When a red-purple porous coordination polymer in a low-spin state is exposed to a gas of an organic compound that induces a high-spin state, the gas is taken into the inside of a jungle gym type skeleton and becomes orange in the high-spin state by a spin crossover phenomenon. Examples of the gas of the organic compound include organic combustible gas and vapor of a volatile organic solvent. That is, the porous coordination polymer in the low spin state adsorbs the gas of an electrolyte solution for a lithium ion secondary battery such as dimethyl carbonate (DMC), diethyl carbonate (DEC) and ethylmethyl carbonate (below, EMC), and the gas generated by decomposition of the electrolyte solution such as ethylene and propylene in the atmosphere, and changes to orange in the high spin state. As described above, the porous coordination polymer can be used as a gas detection material by visually confirming the color tone, confirming the change in mass of the gas adsorbed by the porous coordination polymer, or analyzing the gas adsorbed inside the porous coordination polymer.

The composition of the porous coordination polymer of the present embodiment can be confirmed by using ICP emission spectroscopy, carbon sulfur analysis, oxygen-nitrogen-hydrogen analysis, or the like.

The spin state of the porous coordination polymer of the present embodiment can be confirmed by observing the response of magnetization to a magnetic field using a superconducting quantum interference magnetometer (SQUID) or a vibrating sample magnetometer (VSM).

The size of the crystal particles of the porous coordination polymer of the present embodiment is not particularly limited, but for example, the long axis length is preferably 0.2 μm or more and 100 μm or less. Large particles larger than 100 μm tend to have poor adhesion. Particles smaller than 0.2 μm tend to have low visibility. The aspect ratio (long axis/short axis ratio) of the particles is preferably 1.1 to 30.

For qualitative analysis of the gas adsorbed on the porous coordination polymer of the present embodiment, a method of confirming the mass number of the generated gas using a gas chromatograph mass spectrometer equipped with a double-shot pyrolyzer can be used.

(Method for Producing Porous Coordination Polymer)

In the method for producing the porous coordination polymer of the present embodiment, first, a divalent iron salt; an antioxidant; and tetracyanonickelate, tetracyanopalladate, and tetracyanoplatinate are reacted in a suitable solvent to obtain an intermediate. Second, a porous coordination polymer can be obtained by dispersing the intermediate in a suitable solvent, adding pyrazine to the dispersion to precipitate, and then the precipitate is filtered and dried.

As the divalent iron salt, ferric sulfate heptahydrate, ammonium iron sulfate hexahydrate or the like can be used. As the antioxidant, L-ascorbic acid or the like can be used. As the tetracyanonickelate, potassium tetracyanonickelate hydrate or the like can be used. As the tetracyanopalladate, potassium tetracyanopalladate hydrate or the like can be used. As the tetracyanoplatinate, potassium tetracyanoplatinate hydrate or the like can be used.

As the solvent, methanol, ethanol, propanol and water, or a mixed solvent thereof can be used.

It is preferable that a part or the whole of the porous coordination polymer of the present embodiment is in a low spin state. An example of a treatment method for bringing the porous coordination polymer into a low-spin state includes a method for returning the porous coordination polymer to room temperature after sufficiently cooling it with liquid nitrogen or the like, and a method for bringing the porous coordination polymer into contact with a chemical substance for inducing a low-spin state. Examples of the chemical substance inducing the low-spin state of the porous coordination polymer include acetonitrile and acrylonitrile.

The porous coordination polymer of the present embodiment preferably contains at least one of acetonitrile and acrylonitrile. When the gas detection material is brought into contact with acetonitrile or acrylonitrile vapor, acetonitrile or acrylonitrile is adsorbed in the crystal to induce a low spin state. Therefore, when acetonitrile or acrylonitrile is contained, the porous coordination polymer can be kept in a low spin state.

(Binder)

The binder used in the gas detection sheet of the present embodiment is not particularly limited as long as the porous coordination polymer can be supported on the support and the adhesion between the support and the porous coordination polymer can be maintained. It is also possible to appropriately select the support according to the type of the support used. A binder containing a polymer or a copolymer such as an acrylics-based binder, a styrene-based binder and a butadiene-based binder can be used from the viewpoint of high adhesiveness and ease of use. A plurality of these binders may be mixed and used.

(Binder Content)

The amount of the binder contained in the gas detection sheet of the present embodiment is 4% to 60% by mass based on the mass of the gas detection sheet. The amount of the binder is more preferably 10% by mass or more and 40% by mass or less based on the mass of the gas detection sheet. When the amount of the binder based on the mass of the gas detection sheet is less than 4% by mass, the adhesion is weak, and when the amount of the binder is more than 60% by mass, the gas detection sensitivity tends to decrease.

The amount of binder contained in the gas detection sheet of the present embodiment includes, for example, an amount of a binder contained in a commercially available support used as a raw material.

The amount of binder contained in the gas detection sheet can be determined by a Soxhlet extractor.

After storing the gas detection sheet in a desiccator at 25° C. and a humidity of 10% or less for 24 hours or more, the gas detection sheet is placed in an extraction tube, and acetone is used as the extraction solvent. The extraction solvent of acetone, which is obtained by refluxing the extraction for 24 hours with a heating device such as an oil bath or a mantle heater, is concentrated by using a rotary evaporator, and then the extract is vacuum-dried for 5 hours to determine the amount of binder. From the above, the amount of the binder contained in the gas detection sheet is determined by determining a mass ratio of the binder component to the mass of the gas detection sheet placed in the extraction tube.

When a support, which is partially dissolved in acetone of the extraction solvent, is used, an elution amount to acetone is obtained in advance, and the final amount obtained by subtracting the elution amount of the support to acetone from the mass of the binder component is used as the binder amount.

(Support)

The support used for the gas detection sheet of the present embodiment is not particularly limited as long as the porous coordination polymer can be supported by using the binder.

The support used for the gas detection sheet of the present embodiment is preferably a sheet-like fiber sheet made of, for example, fibers. As the fiber sheet, for example, a nonwoven fabric (including paper), a woven fabric, a knitted fabric or the like can be used.

It is preferable that the support used for the gas detection sheet of the present embodiment has a constant opacity at least at a position where gas is detected (for example, the gas detection section according to the embodiment described later). In particular, when the support is a fiber sheet, the influence of the background color transmitted through the fiber sheet becomes small, and the visibility when the color of the porous coordination polymer changes by the detection gas becomes high. The opacity of the support can be evaluated by the opacity test method of JIS P 8149: 2000, for example. The opacity of the support used for the gas detection sheet of the present embodiment is preferably 50% or more, more preferably 70% or more.

When the support used for the gas detection sheet of the present embodiment is a woven fabric or knitting, for example, a woven fabric or knitting composed of warps and wefts woven by using one or more kinds of woven yarns (natural fiber or artificial fiber) can be used.

The nonwoven fabric used for the support of the gas detection sheet according to the present embodiment is a fiber sheet, a web or a batt in which fibers are unidirectionally or randomly oriented and are bonded to each other by entanglement and/or fusion and/or adhesion. “Nonwoven fabric” of the present invention includes paper, but excludes textiles and knitting.

When the support used for the gas detection sheet of the present embodiment is a nonwoven fabric, the fiber as the raw material of the nonwoven fabric may be a natural fiber, a regenerated fiber of a natural fiber, an organic chemical fiber, a carbon fiber, a glass fiber, a metal fiber, or the like. Among them, from the viewpoint of adhesion with the porous coordination polymer, a regenerated fiber of a natural fiber and an organic chemical fiber are preferable. Two or more of these fibers can be used.

The natural fiber includes cellulose pulp, cotton, hemp (jute, sisal, linen, ramie, kenaf), silk, and wool fiber.

Examples of the regenerated fiber of the natural fiber include rayon and the like.

Examples of the material of the organic chemical fiber include a polyolefin resin, a (meta)acrylic resin, a vinyl chloride resin, a styrene resin, a polyester resin, a polyamide resin, a polycarbonate resin, a polyurethane resin, a thermoplastic elastomer, and a cellulose resin.

The polyester resin is preferably an aromatic polyester resin (polyethylene terephthalate (PET), polytrimethylene terephthalate, polybutylene terephthalate, polyethylene naphthalate, etc.), particularly a polyethylene terephthalate resin such as PET.

As the polyamide-based resin, polyamide 6, polyamide 66, polyamide 610, polyamide 10 and polyamides are used.

The cross-sectional shape of the fiber sheet is not particularly limited, but may be a circular cross-sectional shape, a deformed cross-sectional shape, a hollow cross-sectional shape, or a composite cross-sectional shape. The irregular cross-sectional shape may be, for example, an arbitrary non-circular shape such as an elliptical shape, a triangular shape, a belt shape, a quadrangular shape, a polygonal shape, or a star shape.

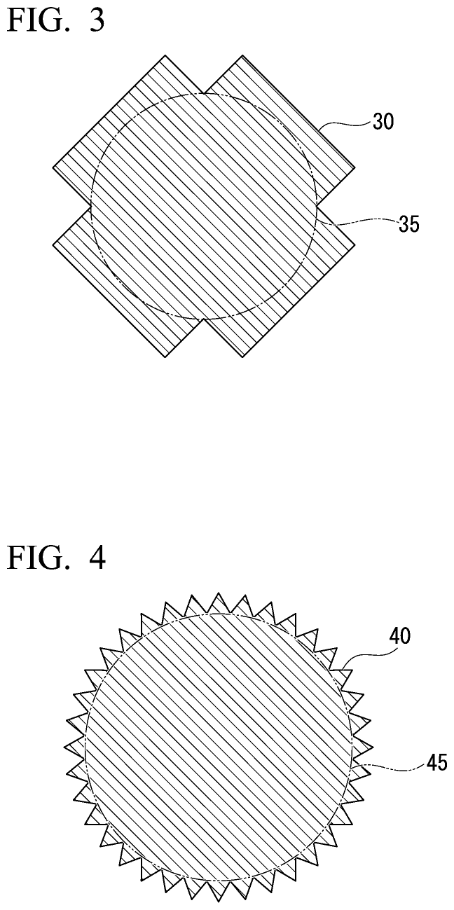

When the support used for the gas detection sheet of the present embodiment is a fiber sheet, it is particularly preferable that the ratio of the circumferential length B of the cross section to the circumferential length A of the inscribed circle of the cross section of the single fiber used for the fiber sheet (B/A) is 1.1 or more. That is, the cross section of the single fiber is preferably a non-circular shape other than a circular shape, for example, a polygonal shape shown in FIG. 3. Alternatively, although the cross section of the single fiber shown in FIG. 4 is a true circle, when the outer surface of the fiber has a large amount of unevenness, the outer peripheral length B is longer than the circumferential length A of the inscribed circle, and the ratio (B/A) thereof can be 1.1 or more.

The ratio of the circumferential length B of the cross section to the circumferential length A of the inscribed circle of the cross section of the single fiber (B/A) is more preferably 1.1 or more, more preferably 1.2 or more. In this case, the adhesion between the porous coordination polymer and the fiber surface is good. The cause of this phenomenon has not yet been fully understood. However, it is inferred that by using a support in which the ratio of the circumferential length B of the cross section to the circumferential length A of the inscribed circle of the cross section of a single fiber (B/A) is 1.1 or more, each particle of the porous coordination polymer is easily supported in the dent of the fiber, and the adhesion is improved by increasing the contact area.

(Evaluation of Cross-Sectional Shape)

Fibers are cut in a direction perpendicular to the longitudinal direction of fibers constituting the support of the gas detection sheet of this embodiment by using a razor. An optical microscope photograph is taken under the same measurement conditions by using a microscope (VHX-5000) manufactured by KEYENCE Corporation for the cross-sectional shape and an image analysis software “NanoHunter NS2k-Pro/Lt” manufactured by Nano Systems Corporation are used to set a threshold value so that the contour of the fiber section becomes clear. And then, the outer peripheral length is obtained by calculating the number of pixels of the contour from the image obtained by the contour extraction process. The circumferential length of the inscribed circle is obtained by obtaining the centroid position of the fiber cross section and the inscribed circle using the same image analysis software, measuring the radius of the inscribed circle, and calculating the circumferential length. The circumferential length A of the inscribed circle of the cross section of the single fiber and the circumferential length B of the cross section determine the ratio (B/A) of the circumferential length B of the cross section to the circumferential length A of the inscribed circle of the cross section of the single fiber from the average value obtained by measuring 10 cross sectional fibers.

When a support composed of fibers having different cross-sectional shapes is used, each of an average value of the circumferential length of an inscribed circle and an average value of the outer circumferential length of the cross-section is obtained by measuring 10 cross-sectional fibers for each of the fibers having a cross-sectional shape. The sums of the values obtained by multiplying the coefficients of the constituent ratios with each the average values are defined as the circumferential length A of the inscribed circle and the outer circumferential length B, respectively. And the ratio of the circumferential length A of the inscribed circle on the cross section of the support composed of fibers having different cross-sectional shapes to the outer circumferential length B of the cross-section is defined as B/A.

The loading amount of the porous coordination polymer of the gas detection sheet is preferably 0.02 mg/cm² or more and 0.4 mg/cm² or less. When the loading amount is 0.02 mg/cm² or more, the color change when the sensing gas is adsorbed on the porous coordination polymer becomes clear, and it is considered that the effect of the color of the support, humidity in the atmosphere, and the influence of volatile organic compounds becomes less. In addition, when the loading amount is larger than 0.4 mg/cm², when a small amount of gas is detected, the color tone change tends to become unclear in a patchy manner due to the presence of the color-changed porous coordination polymer and the color-unchanged porous coordination polymer.

(Measurement of Loading Amount of Porous Coordination Polymer in Gas Detection Sheet)

The method of determining the loading amount of the porous coordination polymer per area of the gas detection sheet of the present embodiment is as follows.

The loading amount of the porous coordination polymer is calculated from the average loading amount of Fe element per area obtained by measuring 10 positions in the region where the porous coordination polymer is supported on the detection sheet by using the thin film Fundamental Parameter Methods of X-ray fluorescence analysis. The loading amount of Fe element per area is calculated by carrying out a measurement at an measured spot with diameter of 3 mm Φ (mask holder made of 5 mm Φ SUS) by using an apparatus of ZSX 100e manufactured by Rigaku Co., Ltd., and removing measured value of the blank of the support as a difference intensity based on the measured value of the blank. The loading amount of the porous coordination polymer is determined from the ratio of the amount of the porous coordination polymer to the amount of Fe element determined by the composition analysis of the porous coordination polymer.

Specific examples of the support used for the gas detection sheet of the present embodiment include, for example, cardboard made of cellulosic fiber such as filter paper (circular quantitative filter paper No. 5, manufactured by ADVANTEC), nonwoven fabric made of polyester fibers (Wintec FP 6020), nonwoven fabric made of polypropylene fibers (Wintec FP 7020), nonwoven fabric made of rayon, polyethylene, and polyester fibers (Wintec FP 9010), woven fabric (product name: polished cloth, material: polyester, nylon) in which polyester fibers and nylon fibers are vertically and horizontally combined, and fiber sheet (knitting) made by knitting fibers of rayon fabric.

(Gas Detection Sheet)

The gas detection sheet according to the present embodiment includes a detection section and a support on which the porous coordination polymer is supported.

At least a part of the porous coordination polymer of the detection section is supported on the support through the binder. For example, when a red-purple porous coordination polymer is used in a low spin state for the detection section, the porous coordination polymer adsorbs the gas in the presence of a gas such as DEC, and changes from red-purple to orange. As described above, when the gas detection sheet of the present embodiment is used in the presence of gas, the presence of gas can be easily detected by visually confirming the difference in color tone between the detection section and the color sample.

The support may be any of the supports. For example, a nonwoven fabric may be used.

(Adhesion Evaluation)

In the gas detection sheet of the present embodiment, the adhesion between the porous coordination polymer and the support can be evaluated by a falling ball test. The adhesion by the falling ball test is evaluated by measuring the falling amount of the porous coordination polymer when a ball is dropped from a fixed height. The falling ball test condition and method will be described in detail in the following Examples.

(Electrochemical Element)

The electrochemical element of the present invention is not limited as long as it has an electrolyte containing a volatile organic compound in a sealed container. Examples of the electrochemical element include lithium ion secondary batteries, electric double layer capacitors, and aluminum electrolytic capacitors. In the electrochemical element, the gas detection material or the gas detection sheet is provided near a surface of the exterior body of the electrochemical element. FIG. 2 is a schematic view of an electrochemical element secondary battery according to the present embodiment.

The electrochemical element 20 of the present embodiment includes a battery section 21 and an exterior body 22 for housing the battery section 21. The battery section 21 comprises a positive electrode plate, a negative electrode plate, and a separator interposed therebetween. The battery section 21 is wound into a jelly roll type or laminated into a stack type in a state where a positive electrode plate, a separator, and a negative electrode plate are arranged in this order.

The positive electrode tabs 23 and the negative electrode tabs 24 electrically coupled to the respective electrode plates of the battery portion 21 are exposed to the outside of the sealed surface 26 of the exterior body 22. Portions of the electrode tabs 23 and 24 in contact with the sealed surface 26 are covered with respective insulating tapes 25.

The gas detection sheet 10 is attached on the exterior body 22. The exterior body 22 is composed of a non-sealed surface for housing the battery section 21 in the center part and a sealed surface bonded to form a bag shape. The adhesive portion having the electrode exposed portion is referred to as a sealed surface 26. The place where the gas detection sheet 10 is attached is not particularly limited.

Gas can be detected by providing the gas detection material or the gas detecting sheet 10 near the surface of the exterior body of the electrochemical element of the present embodiment. For example, in the case where the electrochemical element of the present embodiment is a lithium ion secondary battery, the lithium ion secondary battery uses a cyclic or chain carbonate electrolyte solution as described above, and chain carbonates such as DMC and DEC have relatively low boiling points, so that when the sealability of the exterior body is insufficient or a pinhole or the like occurs in the exterior body, the vapor of these electrolyte solution components leaks as an outgas. When the gas detection material is brought into contact with the leaked gas, the leaked gas is adsorbed in the porous polymer, and at the same time, the electronic state changes from low spin to high spin, and the color tone changes. By visually comparing differences in color tone using color samples (for example, the standard paint color 2013 G version, manufactured by the Japan Paint Manufacturers Association) separately prepared, the leaked gas can be easily detected.

By using the lithium ion secondary battery of the present embodiment, leaked gas can be detected even in processes other than the inspection process, and can be detected during transportation or storage.

### EXAMPLES

The present invention will be described below with reference to more detailed examples, but the present invention is not limited to these examples.

### Synthesis Example 1

(Preparation of Porous Coordination Polymers)

0.27 g of ammonium iron (II) sulfate hexahydrate, 0.08 g of L-ascorbic acid and 0.15 g of potassium tetracyanonickel (II) monohydrate were stirred with a stirring blade in a Erlenmeyer flask containing 240 mL of a mixed solvent of distilled water and ethanol, and the precipitated intermediate particles were filtered and washed with pure water, and dried and recovered in an oven at 50° C. And then, 0.1 g of the obtained intermediate particles were dispersed in ethanol, and 0.08 g of pyrazine was charged over 28 minutes. The precipitated precipitate was filtered and dried in air at 140° C. for 3 hours to give an orange porous coordination polymer.

### Example 1

(Preparation of Gas Detection Sheet)

50 mg of the porous coordination polymer of Synthesis Example 1 and 100 mg of acrylics-based binder powder (solid content of Voncoat, manufactured by DIC) as a binder component were added to 50 ml of acetonitrile to obtain a dispersion containing the porous coordination polymer. The nonwoven fabric (Wintec FP 7020) was repeatedly spray-coated with the obtained dispersion so that the loading amount of the porous coordination polymer was 0.25 mg/cm², and then dried in an oven at 30° C. to prepare the gas detection sheet of the present example. The amount of the binder in the red-purple gas detection sheet obtained was determined by the method described above, and the amount of the binder was 4% by mass based on the mass of the gas detection sheet.

(Detection of Diethyl Carbonate Gas)

A small fan and a gas detection sheet were placed in a 5-liter Tedler bag, and air containing DEC was fed into the Tedler bag to fill it up to a concentration of 5 ppm. When the color tone change of the gas detection sheet was confirmed, the detection section of the gas detection sheet changed to orange, and the difference in color tone was confirmed visually by comparing it with a color sample. On the other hand, when air containing no diethyl carbonate was fed, the color of the detection section did not change, and a difference in color tone could be confirmed. As a result, it was confirmed that diethyl carbonate could be detected by color tone change. The visual recognition time of the color tone change was measured and the results are shown in Table 1.

(Detection of Other Gases)

When the color tone change of the gas detection sheet was similarly confirmed using ethylene, propylene, toluene, xylene, acetone, ethyl acetate, tetrahydrofuran, methanol, ethanol, n-propanol, isopropanol, ammonia, dimethylamine, trimethylamine, triethylamine, acetic acid, formaldehyde, acetaldehyde, diethyl ether, dimethyl carbonate, or ethylmethyl carbonate in place of diethyl carbonate, the detection section of the gas detection sheet changed to orange, and the difference in color tone was confirmed by comparing with a color sample.

(Detection of Leakage Gas in Lithium-Ion Secondary Batteries)

Two gas detection sheets attached with an adhesive tape were prepared near the sealed surface of the exterior body of the lithium ion secondary battery. In one of them, a pinhole was artificially opened at one place by a needle on the assumption that a pinhole was generated in an exterior body, and each was placed in a Tedler bag and left for one hour in a sealed state. When the gas detection sheet of the lithium-ion secondary battery was visually checked, it was found that the detection section of the gas detection sheet of the lithium-ion secondary battery in which the pinhole was formed was orange. When 10 μL, of air in the Tedler bag containing the lithium ion secondary battery was sampled by a gas-tight syringe and analyzed using a gas chromatograph, about 5 ppm of diethyl carbonate was detected. On the other hand, when air in a Tedler bag containing a lithium ion secondary battery in which the gas detection sheet was not discolored was sampled and analyzed for its component, the gas component derived from the electrolyte was not detected.

(Evaluation of Cross-Sectional Shape)

In the gas detection sheet obtained in the present Example, the ratio (B/A) of the circumferential length A of the inscribed circle of the cross section of the single fiber obtained by the above-described method to the outer circumferential length B of the cross section is shown in Table 1.

(Adhesion Evaluation)

In the gas detection sheet obtained in this embodiment, the adhesion between the porous coordination polymer and the support was evaluated by a falling ball test. The falling amount of the porous coordination polymer was measured when a stainless steel (SUS) sphere dropped from a height of 10 cm from the gas detection sheet installation surface. The falling ball test was conducted by the following method under the following conditions.

A medicine package paper was placed on a support table, then a test piece was placed on the medicine package paper. And then, a stainless steel ball was dropped into the center of the test piece. After dropping, the mass of the falling porous coordination polymer powder (binder-containing) on the medicine package paper is measured by an electronic balance. The adhesion is evaluated from the quantity. If the mean dropout amount obtained in the three tests is greater than 0.2 mg, the test shall be given as “C”. If the mean dropout amount is greater than 0.1 mg but not more than 0.2 mg, the test shall be given as “B”. If the mean dropout amount is 0.1 mg or less, the test shall be given as “A”.

<Falling Ball Test Conditions>

Material of the ball: stainless steel (SUS)

Size and weight: sphere diameter 10.0 mmφ, weight 16.67 g

Support base: 2 mm thick vinyl chloride cutter mat

Test pieces: Gas detection sheet,
detection material powder loading amount: 0.25 mg/cm²

Place the side where a large amount of porous coordination polymer powder is supported on the package paper.

Test piece size: 10 mm square

Temperature of the test atmosphere: 20 to 30° C.

Relative humidity of the test atmosphere: 30 to 50%

### Example 2

A gas detection sheet was prepared in the same manner as in Example 1 except that the charge amount of the acrylics-based binder powder was adjusted so that the binder amount was 10% by mass. As in Example 1, the visual recognition time of the color tone change and the adhesiveness were evaluated, and the results are shown in Table 1.

### Example 3

A gas detection sheet was prepared in the same manner as in Example 1 except that the charge amount of the acrylics-based binder powder was adjusted so that the binder amount was 40% by mass. As in Example 1, the visual recognition time of the color tone change and the adhesiveness were evaluated, and the results are shown in Table 1.

### Example 4

A gas detection sheet was prepared in the same manner as in Example 1 except that the charge amount of the acrylics-based binder powder was adjusted so that the binder amount was 60% by mass. As in Example 1, the visual recognition time of the color tone change and the adhesiveness were evaluated, and the results are shown in Table 1.

### Example 5

A gas detection sheet was prepared in the same manner as in Example 1 except that the amount of the acrylics-based binder powder charged was adjusted so that the amount of the binder was 8% by mass by using a nonwoven fabric having a cross-sectional shape of support fibers B/A of 1.1. As in Example 1, the visual recognition time of the color tone change and the adhesiveness were evaluated, and the results are shown in Table 1.

### Example 6

A gas detection sheet was prepared in the same manner as in Example 1 except that the amount of the acrylics-based binder powder charged was adjusted so that the amount of the binder was 8% by mass by using a nonwoven fabric having a cross-sectional shape of support fibers B/A of 1.2. As in Example 1, the visual recognition time of the color tone change and the adhesiveness were evaluated, and the results are shown in Table 1.

### Example 7

A gas detection sheet was prepared in the same manner as in Example 1 except that the amount of the acrylics-based binder powder charged was adjusted so that the amount of the binder was 8% by mass by using a nonwoven fabric having cross-sectional shape of support fibers of B/A=1.5. As in Example 1, the visual recognition time of the color tone change and the adhesiveness were evaluated, and the results are shown in Table 1.

### Comparative Example 1

A gas detection sheet was prepared in the same manner as in Example 1 except that a binder was not contained (0% by mass). As in Example 1, the visual recognition time of the color tone change and the adhesiveness were evaluated, and the results are shown in Table 1.

### Comparative Example 2

A gas detection sheet was prepared in the same manner as in Example 1 except that the charge amount of the acrylics-based binder powder was adjusted so that the binder amount was 1% by mass. As in Example 1, the visual recognition time of the color tone change and the adhesiveness were evaluated, and the results are shown in Table 1.

### Comparative Example 3

A gas detection sheet was prepared in the same manner as in Example 1 except that the charge amount of the acrylics-based binder powder was adjusted so that the binder amount was 2% by mass. As in Example 1, the visual recognition time of the color tone change and the adhesiveness were evaluated, and the results are shown in Table 1.

### Comparative Example 4

A gas detection sheet was prepared in the same manner as in Example 1 except that the charge amount of the acrylics-based binder powder was adjusted so that the binder amount was 3% by mass. As in Example 1, the visual recognition time of the color tone change and the adhesiveness were evaluated, and the results are shown in Table 1.

### Comparative Example 5

A gas detection sheet was prepared in the same manner as in Example 1 except that the charge amount of the acrylics-based binder powder was adjusted so that the binder amount was 70% by mass. As in Example 1, the visual recognition time of the color tone change and the adhesiveness were evaluated, and the results are shown in Table 1.

### Comparative Example 6

A gas detection sheet was prepared in the same manner as in Example 1 except that the charge amount of the acrylics-based binder powder was adjusted so that the binder amount was 80% by mass. As in Example 1, the visual recognition time of the color tone change and the adhesiveness were evaluated, and the results are shown in Table 1.

TABLE 1

| | | Binder | Cross-sectional | | Visual recognition | |
|---|---|---|---|---|---|---|
| | Porous coordination polymer | amount | shape of support | Adhesion | time of color tone | Overall |
| | composition | (% by mass) | fibers A/B | evaluation | change (minutes) | evaluation |
| Example 1 | Fe_{0.99}(Pyrazine)[Ni_{1.0}(CN)₄] | 4 | 1.03 | B | 47 | B |
| Example 2 | Fe_{0.99}(Pyrazine)[Ni_{1.0}(CN)₄] | 10 | 1.03 | A | 50 | A |
| Example 3 | Fe_{0.99}(Pyrazine)[Ni_{1.0}(CN)₄] | 40 | 1.03 | A | 50 | A |
| Example 4 | Fe_{0.99}(Pyrazine)[Ni_{1.0}(CN)₄] | 60 | 1.03 | A | 60 | B |
| Example 5 | Fe_{0.99}(Pyrazine)[Ni_{1.0}(CN)₄] | 8 | 1.1 | A | 48 | A |
| Example 6 | Fe_{0.99}(Pyrazine)[Ni_{1.0}(CN)₄] | 8 | 1.2 | A | 48 | A |
| Example 7 | Fe_{0.99}(Pyrazine)[Ni_{1.0}(CN)₄] | 8 | 1.5 | A | 48 | A |
| Comparative | Fe_{0.99}(Pyrazine)[Ni_{1.0}(CN)₄] | 0 | 1.03 | C | 47 | C |
| Example 1 | | | | | | |
| Comparative | Fe_{0.99}(Pyrazine)[Ni_{1.0}(CN)₄] | 1 | 1.03 | C | 47 | C |
| Example 2 | | | | | | |
| Comparative | Fe_{0.99}(Pyrazine)[Ni_{1.0}(CN)₄] | 2 | 1.03 | C | 47 | C |
| Example 3 | | | | | | |
| Comparative | Fe_{0.99}(Pyrazine)[Ni_{1.0}(CN)₄] | 3 | 1.03 | C | 47 | C |
| Example 4 | | | | | | |
| Comparative | Fe_{0.99}(Pyrazine)[Ni_{1.0}(CN)₄] | 70 | 1.03 | A | not visible due | C |
| Example 5 | | | | | to unclear | |
| Comparative | Fe_{0.99}(Pyrazine)[Ni_{1.0}(CN)₄] | 80 | 1.03 | A | not visible due | C |
| Example 6 | | | | | to unclear | |

With respect to the gas detection sheets of Examples 1 to 7, the adhesion evaluation and the detection test with diethyl carbonate gas were excellent. In the gas detection sheet of Comparative Examples 1 to 4, the detection test with diethyl carbonate gas was good, but in the adhesion evaluation, the porous coordination polymer was often observed to fall off from the support. In the gas detection sheets of Comparative Examples 5 and 6, the adhesion evaluation was good, but in the detection test with diethyl carbonate gas, the color tone change of the detection section after 70 minutes from the start of the test was unclear.

### Example 8

A gas detection sheet was prepared in the same manner as in Example 1 except that a nonwoven fabric (material: rayon, cross-sectional shape of support fibers B/A=1.45) was used as a support and the amount of the acrylics-based binder powder charged was adjusted so that the binder amount was 8% by mass. As in Example 1, the visual recognition time of the color tone change and the adhesiveness were evaluated, and the results are shown in Table 2.

### Example 9

A gas detection sheet was prepared in the same manner as in Example 1 except that a nonwoven fabric (Product name: FP 6020, Wintec, material: polyester, cross-sectional shape of support fibers B/A=1.03) was used as a support and the amount of the acrylics-based binder powder charged was adjusted so that the binder amount was 8% by mass. As in Example 1, the visual recognition time of the color tone change and the adhesiveness were evaluated, and the results are shown in Table 2.

### Example 10

A gas detection sheet was prepared in the same manner as in Example 1 except that filter paper (Product name: Circular quantitative filter paper No. 5, manufactured by ADVANTEC, cross-sectional shape of support fibers B/A=1.03) was used as the support and the amount of the acrylics-based binder powder charged was adjusted so that the binder amount was 8% by mass. As in Example 1, the visual recognition time of the color tone change and the adhesiveness were evaluated, and the results are shown in Table 2.

### Example 11

A gas detection sheet was prepared in the same manner as in Example 1 except that the amount of the acrylics-based binder powder charged was adjusted so that the amount of the binder was 8% by mass by using polished cloth: a woven fabric (Product name: Ultrafine fiber polished cloth, made by Kuraray, material: polyester, nylon, cross-sectional shape of support fibers B/A=2.1) as a support. As in Example 1, the visual recognition time of the color tone change and the adhesiveness were evaluated, and the results are shown in Table 2.

### Example 12

A gas detection sheet was prepared in the same manner as in Example 1 except that a knitting made from rayon (material: rayon, cross-sectional shape of support fibers B/A=1.45) was used as a support, and the amount of the acrylics-based binder powder charged was adjusted so that the binder amount was 8% by mass. As in Example 1, the visual recognition time of the color tone change and the adhesiveness were evaluated, and the results are shown in Table 2.

TABLE 2

| | | | Binder | Cross-sectional | | Visual recognition | |
|---|---|---|---|---|---|---|---|
| | Porous coordination polymer | | amount | shape of support | Adhesion | time of color tone | Overall |
| | composition | Support material | (% by mass) | fibers A/B | evaluation | change (minutes) | evaluation |
| Example 8 | Fe_{0.99}(Pyrazine)[Ni_{1.0}(CN)₄] | Nonwoven fabric | 8 | 1.45 | A | 50 | A |
| | | (rayon) | | | | | |
| Example 9 | Fe_{0.99}(Pyrazine)[Ni_{1.0}(CN)₄] | Nonwoven fabric | 8 | 1.02 | B | 48 | B |
| | | (polyester) | | | | | |
| Example 10 | Fe_{0.99}(Pyrazine)[Ni_{1.0}(CN)₄] | Filter paper | 8 | 1.03 | B | 51 | B |
| Example 11 | Fe_{0.99}(Pyrazine)[Ni_{1.0}(CN)₄] | Woven fabric | 8 | 2.1 | A | 47 | A |
| | | (polyester, nylon) | | | | | |
| Example 12 | Fe_{0.99}(Pyrazine)[Ni_{1.0}(CN)₄] | Knitting (rayon) | 8 | 1.45 | A | 48 | A |

For the gas detection sheets of Examples 8 to 12, the adhesion evaluation and the detection test with diethyl carbonate gas were satisfactory.

### Example 13

A gas detection sheet was prepared in the same manner as in Example 1 except that a styrene (Voncoat SK solid content, manufactured by DIC) was used as a binder and the charged amount was adjusted so that the binder amount was 8% by mass. As in Example 1, the visual recognition time of the color tone change and the adhesiveness were evaluated, and the results are shown in Table 3.

### Example 14

A gas detection sheet was prepared in the same manner as in Example 1 except that a butadiene (Lacstar solid content, manufactured by DIC) binder was used and the charged amount was adjusted so that the binder amount was 8% by mass. As in Example 1, the visual recognition time of the color tone change and the adhesiveness were evaluated, and the results are shown in Table 3.

### Example 15

A gas detection sheet was prepared in the same manner as in Example 1 except that a styrene-acrylic (Dick Fine solid content, manufactured by DIC) was used as a binder and the charged amount was adjusted so that the binder amount was 8% by mass. As in Example 1, the visual recognition time of the color tone change and the adhesiveness were evaluated, and the results are shown in Table 3.

### Example 16

A gas detection sheet was prepared in the same manner as in Example 1 except that a mixed powder of acrylic (Voncoat solid content, manufactured by DIC) and styrenic (Voncoat SK solid content, manufactured by DIC) in a weight ratio of 1:1 was used as a binder and the amount of the binder was adjusted so that the amount of the binder was 8% by mass. As in Example 1, the visual recognition time of the color tone change and the adhesiveness were evaluated, and the results are shown in Table 3.

### Example 17

A gas detection sheet was prepared in the same manner as in Example 1 except that a mixed powder of an acrylic resin (Voncoat solid content, manufactured by DIC) and a butadiene resin (Lacstar solid content, manufactured by DIC) in a weight ratio of 1:1 was used as a binder and the amount of the binder was adjusted so that the amount of the binder was 8% by mass. As in Example 1, the visual recognition time of the color tone change and the adhesiveness were evaluated, and the results are shown in Table 3.

### Example 18

A gas detection sheet was prepared in the same manner as in Example 1 except that a mixed powder of an acrylic (Voncoat solid content, manufactured by DIC), a styrenic (Voncoat SK solid content, manufactured by DIC) and a butadiene-based (Lacstar solid content, manufactured by DIC) in a weight ratio of 1:1:1 was used as a binder and the amount of the binder was adjusted to 8% by mass. As in Example 1, the visual recognition time of the color tone change and the adhesiveness were evaluated, and the results are shown in Table 3.

TABLE 3

| | | | Binder | Cross-sectional | | Visual recognition | |
|---|---|---|---|---|---|---|---|
| | Porous coordination polymer | Binder | amount | shape of support | Adhesion | time of color tone | Overall |
| | composition | types | (% by mass) | fibers A/B | evaluation | change (minutes) | evaluation |
| Example 13 | Fe_{0.99}(Pyrazine)[Ni_{1.0}(CN)₄] | Styrene | 8 | 1.03 | B | 52 | B |
| Example 14 | Fe_{0.99}(Pyrazine)[Ni_{1.0}(CN)₄] | Butadiene | 8 | 1.03 | B | 53 | B |
| Example 15 | Fe_{0.99}(Pyrazine)[Ni_{1.0}(CN)₄] | Styrene- | 8 | 1.03 | B | 50 | B |
| | | acrylic | | | | | |
| Example 16 | Fe_{0.99}(Pyrazine)[Ni_{1.0}(CN)₄] | Acrylic, | 8 | 1.03 | B | 51 | B |
| | | styrene | | | | | |
| Example 17 | Fe_{0.99}(Pyrazine)[Ni_{1.0}(CN)₄] | Acrylic, | 8 | 1.03 | B | 52 | B |
| | | butadiene | | | | | |
| Example 18 | Fe_{0.99}(Pyrazine)[Ni_{1.0}(CN)₄] | Acrylic, | 8 | 1.03 | B | 50 | B |
| | | styrene, | | | | | |
| | | butadiene | | | | | |

For the gas detection sheets of Examples 13 to 18, the adhesion evaluation and the detection test with diethyl carbonate gas were satisfactory.

### Example 19 to 28 and Comparative Example 7 to 9

A porous coordination polymer and a gas detection sheet were prepared in the same manner as in Example 8, except that ammonium iron (II) sulfate hexahydrate, potassium tetracyanonickel (II) monohydrate, potassium tetracyanopalladate hydrate, and potassium tetracyanoplatinate hydrate were weighed to obtain the compositions shown in Table 2, and the charge amount of acrylics-based binder powder was adjusted so that the binder amount was 10% by mass. As in Example 1, the visual recognition time of the color tone change and the adhesiveness were evaluated, and the results are shown in Table 4.

TABLE 4

| | | Binder | Cross-sectional | | Visual recognition | |
|---|---|---|---|---|---|---|
| | Porous coordination polymer | amount | shape of support | Adhesion | time of color tone | Overall |
| | composition | (% by mass) | fibers A/B | evaluation | change (minutes) | evaluation |
| Example 19 | Fe_{0.98}(Pyrazine)[Ni_{0.98}Pd_{0.02}(CN)₄] | 10 | 1.45 | A | 48 | A |
| Example 20 | Fe_{0.95}(Pyrazine)[Ni_{0.98}Pd_{0.02}(CN)₄] | 10 | 1.45 | A | 50 | A |
| Example 21 | Fe_{1.05}(Pyrazine)[Ni_{0.98}Pd_{0.02}(CN)₄] | 10 | 1.45 | A | 50 | A |
| Example 22 | Fe_{0.98}(Pyrazine)[Ni_{0.90}Pd_{0.10}(CN)₄] | 10 | 1.45 | A | 52 | A |
| Example 23 | Fe_{0.98}(Pyrazine)[Ni_{0.98}Pt_{0.02}(CN)₄] | 10 | 1.45 | A | 48 | A |
| Example 24 | Fe_{1.02}(Pyrazine)[Ni_{0.98}Pt_{0.02}(CN)₄] | 10 | 1.45 | A | 48 | A |
| Example 25 | Fe_{0.98}(Pyrazine)[Ni_{0.94}Pt_{0.06}(CN)₄] | 10 | 1.45 | A | 48 | A |
| Example 26 | Fe_{0.98}(Pyrazine)[Ni_{0.98}Pd_{0.01}Pt_{0.01}(CN)₄] | 10 | 1.45 | A | 47 | A |
| Example 27 | Fe_{0.98}(Pyrazine)[Ni_{0.86}Pt_{0.09}(CN)₄] | 10 | 1.45 | A | 53 | A |
| Example 28 | Fe_{0.98}(Pyrazine)[Ni_{0.86}Pt_{0.14}(CN)₄] | 10 | 1.45 | A | 53 | A |
| Comparative | Fe_{0.94}(Pyrazine)[Ni_{0.98}Pd_{0.02}(CN)₄] | 10 | 1.45 | A | not visible due | C |
| Example 7 | | | | | to unclear | |
| Comparative | Fe_{1.06}(Pyrazine)[Ni_{0.98}Pd_{0.02}(CN)₄] | 10 | 1.45 | A | not visible due | C |
| Example 8 | | | | | to unclear | |
| Comparative | Fe_{0.98}(Pyrazine)[Ni_{0.84}Pt_{0.16}(CN)₄] | 10 | 1.45 | A | not visible due | C |
| Example 9 | | | | | to unclear | |

For the gas detection sheets of Examples 19 to 28, the adhesion evaluation and the detection test with diethyl carbonate gas were satisfactory. In the gas detection sheet of Comparative Example 7 to 9, the adhesion evaluation was good, but in the detection test with diethyl carbonate gas, the color tone change of the detection section after 70 minutes from the start of the test was unclear.

From the above results, the gas detection sheet of the embodiment has excellent adhesiveness and gas detection sensitivity, and the leakage gas can be detected by providing the gas detection sheet in the lithium ion secondary battery.

### DESCRIPTION OF THE SIGN

1 Porous Coordination Polymer
2 Iron Ion
3 Tetracyanonickelate Ion
4 Pyrazine
10 Gas Detection Sheet
20 Lithium Ion Secondary Battery
21 Battery Portion
22 Exterior Body
23 Positive Tab
24 Negative Tab
25 Insulation Tape
26 Sealed Surface of Exterior Body

1. A gas detection sheet comprising:
a support, and
a porous coordination polymer which is represented by general formula (1) and supported on the support,
Feₓ(Pyrazine)[Ni_{1-y}M_{y}(CN)₄] (1)
wherein 0.95≤x≤1.05, M=Pd, Pt, 0≤y<0.15), and
further comprising a binder of 4% to 60% by mass based on a mass of the gas detection sheet.

2. The gas detecting sheet according to claim 1,
wherein the support is a fiber sheet comprising fibers, and
a ratio (B/A) of an outer circumferential length B of a cross section to a circumferential length A of an inscribed circle of a cross section of a single fiber of the fibers is 1.1 or more.

3. An electrochemical element comprising the gas detection sheet according to claim 1,
wherein the gas detection sheet is provided near a surface, and
the electrochemical element uses an electrolyte comprising a volatile organic compound.
